(19) United States
(12) Patent Application Publication
(10) Pub. No.: US 2023/0174792 A1
(43) Pub. Date: Jun. 8, 2023

(54) COATING COMPOSITION FOR METALLIC PRODUCTS AND RELATIVE METHOD

(71) Applicant: DANIELI & C. OFFICINE MECCANICHE S.P.A., Buttrio (IT)

(72) Inventors: Alessandra PRIMAVERA, Faedis (IT); Selena TIBURZIO, Cervignano del Friuli (IT)

(21) Appl. No.: 17/996,801

(22) PCT Filed: Apr. 22, 2020
(86) PCT No.: PCT/IT2020/050103

§ 371 Date: Oct. 21, 2022

(51) Int. Cl. C09D 5/10; C09D 5/18; C09D 7/61; C09D 183/04

(52) U.S. Cl. CPC C09D 5/10; C09D 5/18; C09D 7/61; C09D 183/04; C08K 2003/343

(57) ABSTRACT

Coating composition to be applied externally to metal products, to protect said metal products from hot oxidation, and corresponding method.

### FIELD OF THE INVENTION

Embodiments described here concern a coating composition to protect metal products from hot oxidation. The present invention also concerns a method to protect metal products from hot oxidation, for example cast metal products or coming from a cold charge, as well as to metal products coated with the coating composition described here or obtained by said method. In particular, the coating composition and the respective method are used to protect the metal products from oxidation before they are subjected to heating and/or more complex heat treatments.

### BACKGROUND OF THE INVENTION

It is known that in the iron and steel processes for the production and working of metal products, in particular products with a large surface, such as for example slabs and blooms, or long products, such as for example billets, the phenomenon often arises of oxidation and scale formation on their external surface, with consequent loss of material that can be sold.

The scale is associated with the formation of oxides, in particular iron oxides, on the surface of the product, and therefore with surface oxidation reactions.

The formation of surface scale is a very significant problem, which has a considerable impact on the production yield of steel plants.

It has in fact been estimated that the weight losses of metal on the mass of the final product at the end of the process, with respect to the total weight of the mass initially cast and/or charged, can amount to about 2-3%.

It has also been found that approximately 0.2% of these losses occur in the casting area, 0.8% in the heating furnace area, 0.7-1% in the rolling step and 0.6-0.8% in the heat treatment and storage area. Losses of this size, although obviously subject to variations according to the type of product and the specific working methods, translate into a high economic impact for the producers.

Possible causes that lead to the formation of scale can be, for example, the numerous working steps typically performed in contact with the air, or thermal cycles to increase and reduce the temperature to which the metal product is subjected.

For example, when the formation of scale occurs in the initial or intermediate working steps of the iron and steel processes, as mentioned above, it interferes with the working operations that take place downstream, and also reduces the mass and value of the final product compared to the one worked.

Particularly critical working steps in this sense can be the heat treatments, for example in the heating furnace, which have the function of bringing the metal products to an optimal thermal level for subsequent working, bringing or keeping the cast metal products at temperature, making their thermal profile uniform, or heating products coming from external storage areas, kept at ambient temperature or at temperatures lower than the desired one.

In fact, in certain processes, for example hot rolling, the presence of surface scale on the metal products can damage the surface of the product since, because the scale is pressed by the rollers toward the inside of the metal product, it can remain incorporated in the surface of the metal product, leading to surface irregularities that compromise the quality of the final product.

The formation of scale therefore entails, not only an economic disadvantage due to the mass losses of the metal products, but also the deterioration of the quality of the product, due to fragments of scale that remain adhering to the product at the end of the process.

The presence of this scale, as well as the disadvantages described heretofore, also entails problems from a plant engineering point of view, as the fragments of scale can enter the interstices of the machines, for example into bearings or other rotating members, making maintenance difficult, and contributing to decrease the useful life of the elements of the line.

Furthermore, when the fragments remain attached to the surface of the rolling rollers, they can leave impressions on the surfaces of many types of rolled metal products, compromising their quality.

One known method for at least partly removing the scale from the surface of the products is the so-called descaling operation, performed for example by means of water jets and carried out before rolling.

However, descaling entails a cleaning operation, both in the transit areas of the product and also in the descaling area, which also entails the need to separate the descaling water from the scale removed.

Moreover, often the descaling systems currently in use are unable to completely eliminate the scale from the surface of the product.

Ideally, if the scale is kept intact and adheres firmly to the metal product, it could possibly carry out a protective action on the product, for example during the heat treatments to which it is subjected. However, in reality this circumstance does not typically occur, due to the inevitable breakage of the scale that occurs during plant operations.

Since the scale in fact mainly consists of oxides, it has mechanical characteristics that are significantly different from those of the metal product from which it originates, in particular being more fragile and less elastic.

The breakage of the scale promotes the entry into the metal product of air, humidity and oxidizing agents, which react with the most exposed layer of metal and oxides, promoting the formation of further oxides, for example ferrous and/or ferric.

These oxides increase in volume, causing the detachment of the scale and consequently increasing the oxidizing effect of the contact between the surface of the product and the oxidizing agents.

Another disadvantage is that the oxidizing agents can also react with the carbon possibly present in the metal product, producing phenomena of surface decarburization which can alter the composition and content of the surface layers of the metal product.

In the state of the art, methods are known to prevent, or limit, the formation of scale, by coating the surface of the product with layers of mixed oxides, in order to form a barrier between the metal product and the external environment.

Examples of this type are reported in the patent documents CN1935921A, JP5171261A, CN101462859A, JP11222564A.

However, these technologies based on the use of oxides have some disadvantages.

A first disadvantage is that, during heat treatments, for example in a heating furnace, the different layers of material present in the metal product, for example the metal layer, the layers of iron oxide and the layers of coating oxides, can have different coefficients of thermal expansion, which lead to an increase in the internal stress of the material, generating tensions in the structure on a molecular level.

Such tensions then give rise to cracks, in which contact between the product and the oxidizing agents can take place once more, thus triggering new oxidative processes.

Another disadvantage is that at high temperatures (higher than 700° C.) oxygen ions can be diffused through the surface layers, with counter-diffusion of iron ions toward the outside.

These diffusion effects produce oxidation reactions, which lead to the formation of scale and subtract mass from the product.

The article by Torrey Jessica D. et al. is also known: “Composite polymer derived ceramic system for oxidizing environments”, Journal Of Materials Science, Kluwer Academic Publishers, Dordrecht, vol. 41, no. 14, 1 Jul. 2006. This article describes preceramic polymers and expansion agents for producing ceramic composite coatings for protection against oxidation of metal substrates.

There is therefore a need to perfect compositions and methods that prevent the loss of product due to the oxidation of metal products that can overcome, or at least limit, at least one of the disadvantages of the state of the art.

In particular, one purpose of the present invention is to increase the efficiency of the iron and steel processes for the production of metal products, reducing their waste and related costs, in particular associated with the phenomena of scale formation.

It is therefore a purpose of the present invention to provide a composition and a method for the protection of metal products from oxidation phenomena that occur during heat treatments, which can be easily used both for freshly cast products and also for products coming from external storage areas, hot or at ambient temperature.

In particular, it is a purpose of the present invention to reduce oxidation in the heating area by at least 30%, preferably even over 60%.

Another purpose of the present invention is that the composition and implementation of the method are economically sustainable, also in relation to the cost that the loss of metal product due to scale would entail.

Another purpose of the present invention is to increase the quality of the metal products obtained and obtainable by means of the iron and steel manufacturing processes, in particular by eliminating or at least reducing the surface defects associated with the presence of scale during the working steps following the heat treatments.

Another purpose of the present invention is to provide a composition which allows to protect the surface of the metal products from oxidation phenomena, even in the presence of thermal cycles which include significant temperature variations, such as for example the cycles that take place in the heating furnace.

Another purpose of the present invention is to provide protection of the surface of metal products which can be simple to apply and at contained costs.

Another purpose of the present invention is to provide a composition which obtains a coating which, if necessary, can be easily removed and completely eliminated, for example by means of water jets.

The Applicant has devised, tested and embodied the present invention to overcome the shortcomings of the state of the art and to obtain these and other purposes and advantages.

### SUMMARY OF THE INVENTION

The present invention is set forth and characterized in the independent claims, while the dependent claims describe other characteristics of the invention or variants to the main inventive idea.

In accordance with the above purposes, the present invention concerns a coating composition to be applied externally to metal products, for the protection from hot oxidation of metal products.

According to the present invention, the coating composition comprises a matrix in which there is at least one ceramic precursor polymer and first fillers with reducing characteristics, selected from a group comprising: elemental iron powder, elemental silicon powder, iron-silicon powder, Silicon Carbide powder, ferroalloy powder, or combinations thereof.

In some embodiments, the coating composition also comprises second fillers. The second fillers are advantageously able to contrast and reduce the formation of a molten layer of Fayalite and therefore contrast its harmful effects on the oxidation of the substrate. The formation of compounds with a low melting point, such as Fayalite in particular, in the temperature range comprised between 1100-1300° C., typical of the heat treatments to which the metal product is subjected, is deleterious for the oxidation of the substrate, as explained in detail below.

In some embodiments, the second fillers contain a mineral source of Forsterite.

In some embodiments, the source of Forsterite comprises the Olivine mineral.

In some embodiments, the source of Forsterite comprises Magnesium Oxide.

In some embodiments, the source of Forsterite comprises the mineral Olivine and Magnesium Oxide. In other words, the second fillers advantageously comprise Olivine and Magnesium Oxide.

The second fillers, thanks to their reactivity, reduce the deleterious effect of Fayalite, which is typically generated at a temperature above 1150° C.; in fact, from this temperature upward the Fayalite would melt, generating a liquid layer that promotes the mobility of the ions and therefore cause oxidation.

Preferably, in the embodiments which provide to use a source of Forsterite, this is able to form a solid solution with Fayalite, able to significantly raise the melting temperature.

Advantageously, in the embodiments where the source of Forsterite comprises Magnesium Oxide, this is able to form Forsterite in situ, with the above advantages.

The coating composition according to the present description is advantageously applied to metal products to be subjected to heat treatments.

The present invention also concerns the use of the coating composition for the protection of metal products from oxidation.

The present invention also concerns a method to protect a metal product from oxidation by coating the metal product by applying the coating composition externally and obtaining an external protection layer.

The present invention also concerns a method for heating metal products, comprising:
protecting the metal products against oxidation, before heating them;
subjecting the metal product to heating.

The present invention also concerns a method to subject a metal product to treatment, which comprises protecting the metal product from oxidation by coating the metal product by applying the coating composition externally and obtaining an external protection layer, and subsequently subjecting the coated metal product to heating.

The present invention also concerns metal products coated with the coating composition and metal products that have a coating layer which protects them against hot oxidation by means of the coating composition.

The present invention also concerns a hot working line for metal products comprising at least one heating furnace and an apparatus for protecting metal products against hot oxidation.

In some embodiments, upstream of the heating furnace, the apparatus comprises an application station, configured to apply the coating composition of the present invention on the surface of the metal product and, downstream of the heating furnace, a removal station, configured to remove the coating composition of the present invention from the surface of the metal product.

### ILLUSTRATION OF THE DRAWINGS

These and other characteristics of the present invention will become apparent from the following description of some embodiments, given as a non-restrictive example with reference to the attached drawings wherein:

FIG. 1 shows, by way of example, a schematic model of the coating composition applied to a metal product;

FIG. 2 shows schematically a line for working metal products in which there is an apparatus according to embodiments of the present invention.

To facilitate comprehension, the same reference numbers have been used, where possible, to identify identical common elements in the drawings. It is understood that elements and characteristics of one embodiment can conveniently be incorporated into other embodiments without further clarifications.

### DESCRIPTION OF SOME EMBODIMENTS

We will now refer in detail to the various embodiments of the present invention, of which one or more examples are shown in the attached drawings. Each example is supplied by way of illustration of the invention and shall not be understood as a limitation thereof. For example, the characteristics shown or described insomuch as they are part of one embodiment can be adopted on, or in association with, other embodiments to produce another embodiment. It is understood that the present invention shall include all such modifications and variants.

Before describing these embodiments, we must also clarify that the present description is not limited in its application to details of the construction and disposition of the components as described in the following description using the attached drawings. The present description can provide other embodiments and can be obtained or executed in various other ways. We must also clarify that the phraseology and terminology used here is for the purposes of description only, and cannot be considered as limitative.

Hereafter we will use the term “bulk”, referred to a material, referring to the part of the material far enough from the regions of the material where exchanges of matter, momentum and heat occur, so as not to perceive their effects.

Hereafter we will use the term “interphase”, referred to the region of separation between two phases, or two different materials, which have different chemical-physical or crystallographic properties or composition, in which, for example, the transition takes place from one phase to the other or from one material to another.

The Applicant has developed a coating composition, suitable to protect the surface of a metal product from hot oxidation phenomena, associated with exposure to an oxidizing environment, in a wide range of temperatures. In particular, the coating composition is advantageously applicable on metal products to protect them from oxidation, before they are subjected to thermal heating treatments. The hot oxidation phenomena in question are typically oxidation phenomena that occur when the metal product is subjected to a temperature above 900° C., in particular for example to heating and/or more complex heat treatments.

The metal product can be of variable shapes and sizes, since the applicability of the coating composition is in no way limited by the morphological characteristics of the material or product on which it is applied.

Here and hereafter in the description, by the expression “metal product” we mean a product consisting essentially of metallic iron, possibly with the presence of other elements suitable to give the metal product the desired characteristics, such as for example in the case of steels with different carbon contents, special steels, high alloy steels, cast iron or other types of metal alloys.

The oxidizing environment can be any liquid or aeriform environment, for example air, comprising at least one oxidizing agent, or an oxidizing chemical species, for example oxygen, carbon dioxide, water, also in the form of water vapor. However, this definition does not exclude the presence of other chemical species, such as for example nitrogen, nitrogen oxides, sulfur oxides, carbon monoxide, methane.

The oxidizing environment can also comprise chemical species typical of the environments associated with the heating furnaces used in the steel industry, such as for example heating furnaces that use fuel.

In these cases, due to the combustion reactions, the oxidizing environment can have low oxygen fractions and, in addition to the chemical species already mentioned, also volatile chemical species associated with the fuel, partly or totally combusted, or even residues of unburnt fuel, such as hydrocarbons.

The coating composition can therefore be advantageously but not exclusively used in iron and steel processes, to limit, and possibly even eliminate, the formation of surface scale on the metal products.

The coating composition also protects the metal product from phenomena of surface decarburization.

In such applications, the metal product can therefore be a slab, a billet, a bloom or any other metal product, or a portion thereof, which can be subjected to thermal heating treatments.

Such heat treatments can be intended for subsequent working such as, by way of example but not limited to, hot rolling.

In some embodiments, the metal products can be cast or come from external storage areas, possibly maintained at temperatures below the desired temperatures.

In these applications, the coating composition is therefore applied to the surface of the metal products exposed to the oxidizing environment.

The coating composition can therefore be applied both on hot metal products, for example downstream of the casting or in the vicinity of the straightening, and also on cold metal products.

In some embodiments, the coating composition of the present invention can comprise a matrix and inorganic fillers, having specific functions, as described below.

In some embodiments, the matrix can comprise a material, or mixture of materials, possibly in a homogeneous phase, suitable to guarantee the cohesion of the coating composition, trapping the fillers.

In some embodiments, the inorganic fillers are dispersed homogeneously inside the matrix.

In some embodiments, the matrix can comprise one or more ceramic precursor polymers, or a mixture of ceramic precursor polymers.

By ceramic precursor polymers we mean materials which at ambient temperature are in the liquid state, with more or less high viscosity, or solid, obtainable in the form of powders, and which, following heating to temperatures above 200° C., can undergo chemical cross-linking reactions, which modify their chemical structure.

Depending on the type and composition of the ceramic precursor polymers and the surrounding environment, further increases in temperature, for example reaching temperatures comprised between 400° C. and 1400° C., can accentuate the cross-linking reactions and/or trigger further reactions, for example, decomposition processes, thermal degradation, pyrolysis or elimination reactions, leading to the formation of a ceramic material.

In some embodiments, possible ceramic precursor polymers can be silicon-based polymers.

In some embodiments, possible ceramic precursor polymers can be chosen from a group comprising: silicone resins, organic resins, silicone oils, silicone pastes, or other silicon-based polymers, or combinations thereof.

In some embodiments, the ceramic precursor polymers can comprise siloxane polymers, or polysiloxanes, which have Si-O bonds with a variable cross-linking degree, to which organic functional groups (-R1, -R2) of variable type can be linked.

These siloxane polymers can have a molecular structure comprising units of the type -Si (R1) (R2) -O-.

In some embodiments, the ceramic precursor polymers can comprise carbosilane polymers, or polycarbosilanes, which have Si-C bonds with a variable cross-linking degree, to which organic functional groups can be linked (-R1, -R2, -R3, R4) of variable type.

The carbosilane polymers can have a molecular structure which comprises units of the type -Si (R1) (R2) -C (R3) (R4) -.

In some embodiments, the ceramic precursor polymers can comprise silazanic polymers, or polysilazans, which have Si-N bonds with a variable cross-linking degree, to which organic functional groups (-R1, -R2, -R3) of variable type can be linked.

The silazanic polymers can have a molecular structure comprising units of the type -Si (R1) (R2) -N (R3) -.

In some embodiments, the ceramic precursor polymers can also comprise silicone resins, silicone oils, and/or silicone pastes, both with cross-linked and also linear molecular structures, which include organic functional groups (-R1, -R2, -R3, -R4).

In some embodiments, the organic functional groups (-R1, -R2, -R3, -R4) can comprise functional groups selected from: hydrogen (-H), alkyl, aryl, alkoxyl groups, possibly in turn substituted with other substituents.

Possible alkyl groups can be methyl groups, possible aryl groups can be phenyl groups and possible alkoxyl groups can be methoxy groups.

In some embodiments, polymethylhydridosiloxane (PMHS), polydimethylsiloxane (PDMS), perhydridosilazans, polyphenylsiloxanes, or combinations thereof can be used as ceramic precursor polymers.

Advantageously, ceramic precursor polymers in which at least one of the organic functional groups linked to a silicon atom (-R1, -R2) is a hydrogen, such as for example polyalkylhydridosiloxanes, polymethylhydridosiloxane (PMHS), perhydridosilazans, can have reducing characteristics that help improve protection of the metal product from hot oxidation.

In some embodiments, the matrix can comprise an organic-inorganic hybrid material.

In some embodiments, the inorganic fillers can comprise first inorganic fillers, hereafter first fillers, with reducing characteristics, which typically can be associated with low oxidation states. In particular, the reducing characteristics of the first inorganic fillers are advantageously exploited according to the present invention for the sacrificial oxidation of the inorganic fillers, so as to protect the metal of the metal product.

In some embodiments, the first inorganic fillers can comprise elemental iron powder, also called metallic iron, and/or elemental silicon powder, also called in some cases metallic silicon, ferro-silicon powder, and/or silicon carbide powder, and/or ferroalloy powders.

In possible implementations, ferroalloy powders can be chosen from Ferro-Chromium, Ferro-Molybdenum, Ferro-Manganese, Ferro-Silicon-Manganese powders.

The iron and silicon used according to possible embodiments are supplied metallic and/or in low oxidation states, or compounds thereof are supplied in low oxidation states, with reducing characteristics.

Here and hereafter in the description, by powder we mean finely divided matter and consisting of a plurality of granules with variable size and substantially comprised between micrometer fractions and 100 µm, preferably between micrometer fractions and 75 µm.

In some embodiments, the first fillers can comprise a Ferro-Silicon powder, for example with a Silicon fraction higher than 50% in weight with respect to the weight of the first fillers, preferably higher than 75%, even more preferably higher than 90%.

In other embodiments, the first fillers can comprise a Silicon Carbide powder. In possible implementations, the first fillers can consist only of Silicon Carbide powder.

Advantageously, when the coating composition is applied on the surface of the metal product, the chemical characteristics linked to the metal components and/or low oxidation states cause any oxidizing agents to oxidize the substances contained in the coating composition, instead of oxidizing the metallic iron of the metal product.

Sacrificial oxidation therefore concerns the fact that the first fillers, in contact with an oxidizing agent, can oxidize instead of the metallic iron of the metal product, which is therefore protected.

In some embodiments of the coating composition, the first fillers are uniformly mixed in the matrix, with a homogeneous distribution.

This characteristic allows, during use, to obtain a uniform protection and barrier effect on the entire surface of the metal product.

In some embodiments, the fillers can comprise second inorganic fillers.

Advantageously, the second fillers are able to contrast and reduce the formation of a molten layer of Fayalite, or in general of compounds having low melting temperatures, and therefore counteract its harmful effects on the oxidation of the substrate.

In some embodiments where the coating composition comprises or consists of a ceramic precursor polymer, first fillers and second fillers, the weight ratio between ceramic precursor polymer and first fillers can be between 1.5 and 4, in particular between 2 and 3.5, and the weight ratio between ceramic precursor polymer and second fillers can be between 0.45 and 0.9, in particular between 0.5 and 0.7.

In some embodiments, the weight ratio between the first fillers and the second fillers is comprised between 0.1 and 0.6, in particular between 0.15 and 0.5, more particularly between 0.15 and 0.4.

In some embodiments, the second fillers can comprise one or more minerals, hereafter also called second fillers.

In some embodiments, the second fillers include at least one mineral having a melting temperature higher than an operating heating temperature, for example comprised between 1100° C. and 1300° C.

In some embodiments, the one or more minerals present in the second fillers can be a mineral source of silicates.

In some embodiments, the one or more minerals present in the second fillers can be, or include, one or more minerals that are a source of Forsterite.

In some embodiments, a mineral that acts as a source of Forsterite present in the second fillers can be a nesosilicate, or orthosilicate, possibly comprised in the group of olivines.

In some embodiments, the second fillers can comprise Olivine, possibly with a predominance of Forsterite.

In some embodiments, the Olivine contained in the second fillers can comprise a fraction of Forsterite greater than 50%, preferably greater than 60%, more preferably greater than 75%, even more preferably greater than 85%.

In some embodiments, in which the first Ferro-Silicon-based fillers and second Olivine-based fillers are present, the weight ratio between Ferro-Silicon and Olivine can, by way of example, be lower than 1, in particular comprised between 0.1 and 0.9, more particularly between 0.15 and 0.8, even more particularly between 0.2 and 0.7.

In some embodiments, in which the first fillers based on Silicon Carbide powder and second fillers comprising Olivine are present, the weight ratio between Silicon Carbide and Olivine can be for example between 0.1 and 0.6, in particular between 0.15 and 0.5, more particularly between 0.2 and 0.4, even more particularly between 0.2 and 0.3.

In some embodiments, the source of Forsterite present in the second fillers can be the mineral Magnesium Oxide. Magnesium Oxide is able to form Forsterite in situ according to the reaction:

$$2 {\text{MgO + SiO}}_{2} = {\text{Mg}}_{2} {\text{SiO}}_{4}$$

In some embodiments, where the first fillers based on Silicon Carbide powder and second fillers comprising Magnesium Oxide are present, the weight ratio between Silicon Carbide and Magnesium Oxide can be for example between 0.1 and 0.6, in particular between 0.15 and 0.5, more particularly between 0.15 and 0.4.

In some embodiments, the second fillers can consist exclusively of Magnesium Oxide.

In other embodiments, the second fillers can comprise both Olivine and also Magnesium Oxide, which advantageously act as a source of Forsterite. In some embodiments, the second fillers can consist of, that is, comprise exclusively, Olivine and Magnesium Oxide.

In some embodiments in which the second fillers comprise both Olivine and also Magnesium Oxide, Olivine is present in a quantity in weight greater than Magnesium Oxide.

For example, the weight ratio between Olivine and Magnesium Oxide can be between 2 and 8, in particular between 3 and 7, more particularly between 3.5 and 6, even more particularly between 4 and 5.5.

In some embodiments, the coating composition can also comprise at least one solvent, or a mixture of solvents, compatible with the matrix, able to solubilize it and obtain a composition of the desired viscosity.

In some embodiments, the solvent can be a highly volatile solvent which ensures rapid drying.

In some embodiments organic solvents can be used, for example acetone, aromatic solvents, esters, ketones, or combinations thereof.

In some embodiments, the composition of the present invention can also comprise additives, known per se, with thickening, dispersing, wetting, antifoaming, rheological modifying and other effects, according to requirements.

In some embodiments, such additives are added in percentages not higher than 5% in weight of the total mass of the coating composition.

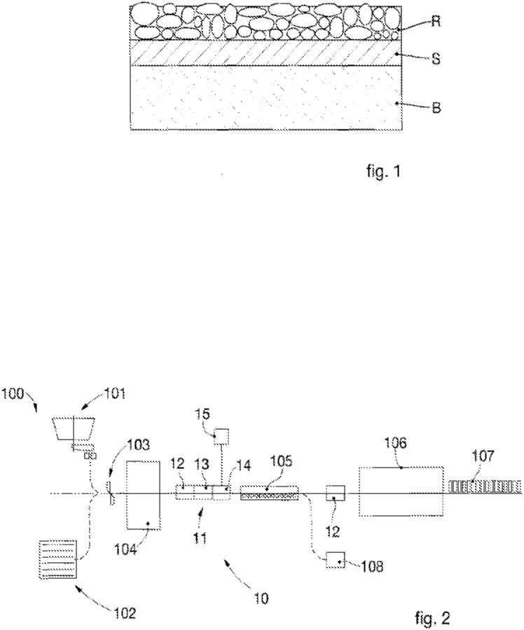

FIG. 1 schematically shows, by way of example, a model of a metal surface of the product coated with the coating composition.

In this representation, the bulk B of the metal product is schematically displayed, in the present case consisting substantially of metallic iron as defined above.

By way of example, on the surface of the metal product a layer of oxides S is shown, which develop in contact with the oxidizing environment, in particular iron oxides.

The oxides can have variable iron contents and oxidation states, and can be present in the form of different crystalline phases, for example hematite, magnetite, wüstite.

On the layer of oxide S, FIG. 1 shows a coating layer R, obtained by means of the coating composition according to some embodiments of the present invention.

As shown by way of example in FIG. 1, advantageously, the coating layer R acts as a barrier layer, which is interposed between the oxidizing agents present in the surrounding environment and the bulk and surface regions of the metal product, carrying out a protective action.

Furthermore, the protective action is also carried out chemically, since the molecules of the oxidizing agent which also managed to penetrate the coating layer R would preferentially react with the first fillers, by sacrificial oxidation, rather than with the iron and/or the other metal elements and/or the carbon contained in the metal product.

Furthermore, the coating layer R also inhibits the counter diffusion of iron atoms and ions from the bulk B of the metal product toward the surface.

This action further contributes to blocking the oxidative processes of the metal product.

In some embodiments, when the metal product is subjected to heat treatments, following a rise in temperature, the matrix undergoes an almost complete cross-linking, and the ceramic material is formed on the surface of the metal product.

In particular, the organic groups (-R1, -R2, -R3, -R4) linked to the structure of the ceramic precursor polymers can condense or degrade already at temperatures above 250° C., up to pyrolysis at higher temperatures, even up to 800° C.

Here and hereafter in the description, the term pyrolysis comprises the set of transformations and chemical reactions that the ceramic precursor polymers undergo, depending on the chemical composition of the environment in which they are inserted, and on the thermal cycle to which they are subjected.

In fact, when the ceramic precursor polymers are in contact with reactive chemical species of the oxidizing environment, combustion or partial combustion reactions or even other similar processes, triggered by the temperature, can occur, which can involve both the metal product and also the chemical species present in the environment with which the metal product comes into contact; for linguistic convenience, these processes will be included in the term pyrolysis.

These processes promote the formation of bonds, in particular Si—Si, Si—O, SiO2—SiOC, Si—C, Si—N in the matrix, which lead to the crosslinking of the chains of the ceramic precursor polymers.

Under these conditions, the coating layer R shown in FIG. 1 can therefore comprise ceramic material.

In some embodiments, the ceramic material which is formed following the cycles of the heat treatments can comprise for example silica, amorphous and/or crystalline, silicon oxycarbon, graphitic carbon, or combinations thereof.

The crystalline silica phases can for example comprise quartz and/or cristobalite.

In general, the ceramic coating can include silicates in amorphous or crystalline phases.

These and/or other mechanisms therefore lead to a loss of mass and a contraction in volume of the matrix.

The presence of inorganic fillers allows to compensate for this behavior, giving mechanical stability to the coating composition.

The Applicant has verified that an effective weight quantity, to obtain this purpose, of the matrix with respect to the sum of the fillers can be comprised in a range between 20% and 50% in weight, preferably between 25% and 33% in weight.

The Applicant has also verified that an effective protective effect is obtained when, after the crosslinking of the matrix, the average thickness of the coating layer R is comprised between 5 and 100 µm, in particular comprised between 20 µm and 60 µm, preferably between 30 µm and 50 µm.

Another effect found by the Applicant is that in the temperature range comprised between 1100-1300° C., typical of heat treatments to which the metal product is subjected, the Silicon compounds, for example containing Silicates, Iron and/or iron oxides, for example wüstite (FeO), can react chemically to form compounds with a low melting point, such as for example Fayalite, which therefore can be melted in some of their phases under the working conditions of the furnace.

The presence of liquid or viscous phases in the interphase zones between the metal product and the surface layers promotes the diffusion of iron ions toward the surfaces, and therefore the oxidation processes. Therefore, the formation of compounds with a low melting point, such as Fayalite in particular, is deleterious for the oxidation of the substrate.

The fact that the second fillers can contain the high fractions of Forsterite, reported in the present description, allows to reduce the formation of the liquid or viscous phases in the interphase zones, further protecting the metal product from phenomena of oxidation. This advantageous aspect is further increased if the second fillers include, in addition to Olivine, also Magnesium Oxide as described above with reference to some embodiments.

Another peculiar effect is the fact that the coating layer R obtainable by means of the coating composition developed by the Applicant has coefficients of thermal expansion close to those of the metal product.

This characteristic allows to limit one of the disadvantages of the state of the art so that the coating layers R, following expansion effects due to heat treatment cycles at high temperatures, can create internal stresses in the metal product, generating tensions in the structure on a molecular level and possibly leading to the detachment or cracking of the coating layer R.

The present invention also concerns a metal product coated with the coating composition previously described, or which has a coating layer R for protection against hot oxidation obtainable by means of a coating composition such as that described here.

The present invention also concerns a method to protect a metal product from oxidation by coating the metal product, by applying the coating composition externally and obtaining an external protection layer.

The method can be advantageously but not exclusively used to protect from oxidation metal products to be heated, such as long products or slabs.

The present invention also concerns a method to treat a metal product, that is, to subject a metal product to treatment.

The treatment method comprises protecting the metal product from oxidation by coating the metal product, by applying the coating composition externally, obtaining an external protective layer, and subsequently subjecting the coated metal product to heating.

Advantageously, downstream of the method, various working operations can be carried out, for example rolling or forging, or even transport and/or storage, after cooling.

The method can in particular limit, if not completely eliminate, the formation of surface scale and/or surface decarburization reactions, in particular due to thermal cycles, possibly carried out by means of a heating furnace.

In some embodiments, the treatment method can also provide to remove the coating layer R from the surface of the metal product after heating the metal product.

In particular, the treatment method of the present invention can comprise:
supplying a metal product;
making available the coating composition of the present invention;
coating the surface of the metal product with the coating composition of the present invention;
subjecting the metal product to heating;
removing the coating composition from the surface of the metal product.

Advantageously, when the metal product treated with the method is subjected to subsequent working processes, for example rolling, the quality of the final product increases, due to the significant reduction in the presence of surface scale and the oxidative processes of surface decarburization.

In some embodiments, the supply of the metal product can provide to cast the metal product or to supply the cold metal product from suitable storage areas.

In particular, the metal product can be a pre-cut product, for example stored in a storage warehouse, which needs to be heated to reach a suitable temperature to be worked.

In some embodiments, before being coated, the metal product can be subjected to descaling, in order to at least partly remove any scale present on the surface, in particular labile scale.

This operation can be performed by means of jets of water, or air, possibly at high pressure or by mechanical means, such as brushes or other, or a combination of these operations. The scale removal environment can be inert or not.

In some embodiments the descaling is carried out in such a way as to avoid excessively subtracting temperature from the metal product.

Furthermore, when water jets are used, the jets can be set, for example oriented, so as not to leave residual water on the surface of the metal product.

In some embodiments where the metal product is hot when it arrives in the descaling step, the heat can contribute to removing possible traces of water.

Some embodiments can also optionally provide a drying step of the metal product, following descaling.

In some embodiments, making the coating composition available can entail preparing the coating composition in the plant, for example along or near a rolling line and/or a heating furnace. The preparation can be performed immediately before use, if necessary.

In other embodiments, making the coating composition available can provide that a certain quantity of coating composition is previously prepared, possibly even in places other than the place where it is used, stored, and transported to the place where it is used, for later use.

In some embodiments, the coating of the metal product can provide to apply the coating composition by spraying techniques.

In some embodiments, the spraying techniques can be based on nebulization, spray, cold spray, airless techniques.

In particular, airless spraying techniques can provide to put the coating composition under pressure by means of a pneumatic system and then to spray it on the metal product by means of a nozzle.

In some embodiments, the pneumatic system can take the coating composition to pressures exceeding 120 bar, and the nozzle can nebulize, or atomize, the flow of coating composition exiting, so as to improve the uniformity and the quality of the deposition on the metal product.

The airless spraying techniques have advantages connected to the reduction of the overspray, that is, the fraction of the coating composition that is not deposited on the surface of the metal product.

The preparation of the coating composition in a form suitable to be applied by spraying techniques can provide the steps of:
grinding and sieving the fillers, in order to obtain a controlled grain size;
weighing the fillers, the matrix, the solvents and any possible additives;
mixing the fillers, the matrix, the solvent, or the mixture of solvents, and any possible additives, in order to obtain a homogeneous composition.

In these embodiments, the coating composition can be in liquid form and also comprise the solvent, or the mixture of solvents, and the fillers can be dispersed and distributed homogeneously in the matrix.

In these embodiments, the first fillers can have a micrometric diameter, possibly with a grain size less than 20 µm, and the second fillers can have a grain size less than 100 µm, in particular less than 60 µm.

In alternative embodiments, the coating of the metal product can provide to apply the coating composition by means of powder coating techniques.

The coating composition in this case can be in the form of a solid powder, and not provide the solvent.

The preparation of the coating composition in a form suitable to be applied by powder coating techniques can provide the steps of:
mixing the materials, in particular the fillers in the matrix;
extrusion;
granulation;
powder grinding;
sieving.

These embodiments can advantageously provide that the components of the coating composition (fillers and matrix) are ground with a grain size in a range comprised between 5 and 60 µm, advantageously between 20 and 30 µm.

In some embodiments, the coating can provide to use pistols able to electrostatically charge the powders of the coating composition. The electrostatic charge promotes the adhesion of the coating composition and the metal product.

The application of the coating composition by powder coating advantageously allows to eliminate costs and other disadvantages related to the use and handling of organic solvents.

Furthermore, the Applicant has verified that powder coating techniques allow to obtain a higher yield of coating composition actually deposited, with respect to the coating composition used, compared with liquid spray systems.

The application of the coating composition by powder coating is also particularly advantageous if the coating composition is applied to hot metal products, for example in the casting or straightening areas.

In some embodiments, the coating of the metal product can also provide to at least partly recover the excess coating composition, possibly to be re-used.

In some embodiments, the coating of the metal product can take place inside a closed tunnel, possibly provided with a suction system to avoid releasing spray dust and vapors into the environment.

In some embodiments, the heating of the metal product can provide a plurality of heat treatment cycles, for example a convective step (pre-heating), a heating step by radiation (heating) and a heat bath step (soaking), so as to obtain at the end a homogeneous temperature profile in the whole volume of the metal product.

In some embodiments, the temperature steps can be associated with temperature ramps, for example set in a heating furnace.

Depending on the working temperature, in particular the temperature increase profile of the temperature ramps, the coating composition can be subjected to different transformations.

For example, in a temperature range comprised between 20° C. and 80° C., preferably between 40° C. and 60° C., a softening of the coating matrix can occur, and even a possible vitreous transition.

Furthermore, in a temperature range comprised between 160° C. and 240° C., preferably between 180° C. and 220° C., cross-linking of the matrix can take place or be triggered.

In some embodiments, the removal of the coating composition from the surface of the metal product, after the heating furnace, can provide to use water jets and/or can be performed with methods similar to descaling.

With reference to the embodiments described in FIG. 2, the present invention also concerns a line 100 for the hot working of metal products, which comprises an apparatus 10 for the protection from hot oxidation of metal products to be subjected to heating and subsequent hot rolling.

In some embodiments, the apparatus 10 can be designed and manufactured in such a way that the operating and maintenance costs do not exceed the costs due to the loss of metal material caused by the presence of scale.

By way of example, the apparatus 10 can be installed in the line 100, possibly downstream of a casting machine 101 or a storage warehouse 102.

By way of example, the line 100 shown in FIG. 2 can also comprise a cutting device 103, a roughing unit 104, a heating furnace 105, a rolling unit 106, or rolling train, and a cooling device 107.

In some embodiments, the line 100 can be suitable to operate in a substantially continuous mode, for example in the mode typically called “endless”, in which the metal product is cast and rolled with no break in continuity, respectively by the casting machine 101, in this case suitable for continuous casting, and by the rolling unit 106.

In alternative embodiments, the line 100 can be suitable to operate substantially in discontinuous mode, for example by providing that metal products of certain sizes are loaded into the line 100 from the storage warehouse 102, and subsequently rolled.

Other embodiments operating in discontinuous mode can provide that the metal product is cast by the casting machine 101 and subsequently cut to the desired length by the cutting device 103, for example configured as shears.

In some embodiments, the apparatus 10 of the present invention can comprise an application station 11 and a removal station 12 to respectively apply and remove the coating composition, possibly located immediately upstream and immediately downstream of the heating furnace 105.

In some embodiments, the application station 11 comprises a descaling unit 12, possibly provided with nozzles for spraying jets of water, or air, possibly at high pressure.

In some embodiments, the application station 11 can also comprise a drying unit 13, possibly provided with nozzles for spraying air jets, possibly hot and at high pressure.

The application station 11 also provides a coating unit 14, suitable to apply the coating composition on the surface of the metal product being worked.

The coating unit 14 can possibly be connected to a mixing unit 15, suitable to prepare the coating composition of the present invention, in particular in a form suitable to be applied, for example, by spraying and/or powder coating techniques.

The coating unit 14 can therefore be provided with nozzles or pistols, or other suitable devices for the application of the coating composition, for example by spraying and/or powder coating techniques.

The nozzles or pistols can be mounted on suitable mobile arms, which can move in predetermined coating patterns, and/or which can be moved by an operator remotely, and/or which can be robotic, or automatically moved by a suitable control program.

The coating unit 14 can also include optical devices, suitable to verify that the surface of the metal product is coated uniformly.

The optical devices can for example comprise video cameras mounted on the walls of the coating unit 14, or even on the mobile arms.

The optical devices can for example comprise infrared sensors which can detect temperature differences on the surface of the metal product, associated with the presence of the coating composition.

In some embodiments, the coating unit 14 can be configured as a closed tunnel, possibly provided with a suction system to avoid releasing spray dust and vapors into the environment.

Embodiments also provide that the coating unit 14 can comprise suitable means for recycling the excess coating composition, not deposited on the metal product.

In some embodiments, the removal station 12 can provide a descaling unit to remove the coating composition at exit from the heating furnace 105, and/or devices suitable to at least partly recover the coating composition removed.

In some embodiments, the removal station 12 can be suitable to send the coating composition recovered to the mixing unit 15.

In some embodiments, the heating furnace 105 can be used to create the coating layer R on the surface of the metal product, triggering the crosslinking of the matrix of the coating composition by heating.

As shown schematically in FIG. 2, at exit from the heating furnace, the coated metal product can then be sent directly to a means of transport 108, after cooling, to be transported elsewhere, sold or worked in a different plant.

In these embodiments, the coating composition or the resulting coating layer R is not removed from the removal station 12.

It is clear that modifications and/or additions of parts or steps may be made to the invention as described heretofore, without departing from the field and scope of the present invention.

It is also clear that, although the present invention has been described with reference to some specific examples, a person of skill in the art shall certainly be able to achieve many other equivalent forms of coating composition, having the characteristics as set forth in the claims and hence all coming within the field of protection defined thereby.

In the following claims, the sole purpose of the references in brackets is to facilitate reading: they must not be considered as restrictive factors with regard to the field of protection claimed in the specific claims.

1. A coating composition to be applied externally to metal products, to protect said metal products from hot oxidation, wherein said composition comprises:
a matrix in which there is at least a ceramic precursor polymer,
first fillers with reducing characteristics chosen from a group comprising: elemental iron powder, elemental silicon powder, iron-silicon powder, silicon carbide powder, ferroalloy powder, or combinations thereof;
second fillers which include one or more minerals comprising a Forsterite mineral source.

2. The coating composition as in claim 1, wherein said Forsterite mineral source comprises Olivine, with a fraction of Forsterite higher than 50%, in particular higher than 60%, more in particular higher than 75%, even more in particular higher than 85%.

3. The coating composition as in claim 1, wherein said Forsterite mineral source comprises Magnesium Oxide.

4. The coating composition as in claim 2 , wherein said Forsterite mineral source comprises Olivine and Magnesium Oxide, wherein the weight ratio between Olivine and Magnesium Oxide is between 2 and 8, in particular between 3 and 7, more in particular between 3.5 and 6, even more in particular between 4 and 5.5.

5. The coating composition as in claim 1 wherein the weight ratio between said first fillers and said second fillers is comprised between 0.1 and 0.6, in particular between 0.15 and 0.5, even more in particular between 0.15 and 0.4.

6. The coating composition as in claim 1 wherein said ceramic precursor polymer is chosen from: silicone resins, silicone oils, silicone pastes, siloxane polymers, carbosilanic polymers, silazanic polymers, or combinations thereof.

7. The coating composition as in claim 1 , wherein said ceramic precursor polymer comprises polymethylhydrosiloxane (PMHS) and/or polydimethylsiloxane (PDMS), polyperhydridosilazane, polyphenylsiloxane, or combinations thereof.

8. The coating composition as in claim 1 , wherein said coating composition is in liquid form, and also comprises a solvent, or a mixture of solvents, said first and second fillers being dispersed and distributed homogeneously in said matrix solubilized by said solvent, or by said mixture of solvents, and having a grain size respectively lower than 20 µm and 30 µm.

9. The coating composition as in claim 8, wherein the fraction of said matrix with respect to said fillers is comprised in a range between 20% and 50% in weight, preferably between 25% and 40% in weight.

10. A metal product coated with a coating composition as in claim 1.

11. The metal product as in claim 10, wherein the coefficient of thermal expansion of the coating layer is close to that of the metal product.

12. A metal to protect a metal product from oxidation by coating said metal product externally, applying a coating composition as in claim 1 , by means of spraying techniques, in particular airless or by powder coating technology, obtaining an external protection layer.

13. A method for treating a metal product comprising protecting said metal product from oxidation by coating said metal product, externally applying a coating composition as in claim 1, obtaining an external protection layer and subsequently subjecting said coated metal product to heating.

14. A hot production line for metal products comprising a heating furnace, wherein it comprises an apparatus to protect the metal products from hot oxidation, said apparatus comprising, upstream of said heating furnace, an application station, configured to apply a coating composition as in claim 1 onto the surface of said metal product and, downstream of said heating furnace, a removal station, configured to remove, from the surface of said metal product, a coating layer for protection from hot oxidation obtained by said coating composition.

15. The hot production line as in claim 14, wherein said application station comprises a coating unit, provided with nozzles to apply said coating composition by means of spraying techniques, in particular airless, and/or powder coating techniques, and a mixing unit , suitable to prepare said coating composition in liquid and/or powder form respectively.
